(19) United States
(12) Patent Application Publication
(10) Pub. No.: US 2017/0186403 A1
(43) Pub. Date: Jun. 29, 2017

(54) Method of simulating print color on mobile devices

(71) Applicants: Shih-Chang Chang, New Taipei City (TW); Chia-Pin Chueh, New Taipei City (TW); Ming-Jiu Huang, New Taipei City (TW); Kuo-Jui Hu, New Taipei City (TW)

(72) Inventors: Shih-Chang Chang, New Taipei City (TW); Chia-Pin Chueh, New Taipei City (TW); Ming-Jiu Huang, New Taipei City (TW); Kuo-Jui Hu, New Taipei City (TW)

(73) Assignee: Printing Technology Research Institute, New Taipei City (TW)

(21) Appl. No.: 14/981,795

(22) Filed: Dec. 28, 2015

(51) Int. Cl. G09G 5/06; G06F 3/12

(52) U.S. Cl. CPC G09G 5/06; G06F 3/1208; G06F 3/1256

(57) ABSTRACT

A method of simulating print color on mobile devices, comprising: obtaining a second group of tristimulus values by a chromaticity measuring device through a measuring method; creating a CIEXYZ color space of the mobile device by the second group of tristimulus values, and transforming the CIEXYZ color space to a sRGB color space via a 1D lookup table and a transformation matrix; obtaining a print color from a ICC profile of an output device by 3D lookup table and generating a second color calibrated profile by finding another color, similar to the print color from the ICC profile of the output device, in the sRGB color space through tone mapping; and simulating the print color on a screen of the mobile device by using the second color calibrated profile, whereby the user can directly preview the printed photo on the screen thereby achieving saving print ink and time.

### FIELD OF THE INVENTION

The present invention is relates to a method of color calibration, particularly to a method of simulating print color on mobile devices (smart phone, tablet computer)

### BACKGROUND OF THE INVENTION

The current mobile device industries are in a rapid development, which make mobile devices have more functions and are close to the person's life; taking photos are now one of the basic functions of mobile devices.

However, the internet is certainly very easy to share the photos, but there are some classic photos still want to print it out and put it into permanent preservation within the frame; but the print color effects are often somewhat drop on the phone screen display, we must continue to adjust parameters to find the right photo printing colors, but the process is quite a waste of time.

In view of this, the technical scheme of the present invention is to solve above mentioned problem and develop a method of simulating print color on mobile devices.

### SUMMARY OF INVENTION

The present invention is to provides a method of simulating print color on mobile devices, comprising:

Step 1: obtaining a second group of tristimulus values by a chromaticity measuring device through a measuring method;

wherein the measuring method comprises:

Step 1-1: respectively selecting a plurality of measuring points in red, green, and blue three primary color chromaticity coordinates from RGB (000, 000,000) to RGB (255, 255, 255), wherein the measuring points are used for measuring three primary color chromaticity coordinates at an interval of every N value from the RGB (000, 000,000), and the N value is a positive integer value from 0 to 255;

Step 1-2: collecting all of the measuring points through the chromaticity measuring device to form a combination of colors, and obtaining the tristimulus values from the combination of colors to set up as a first group of tristimulus values;

Step 1-3: using an interpolation for filling missing values of the first group of tristimulus values caused by the N values therebetween to form a first color calibrated profile which is used to adjust the color of screen of the mobile device from the first to the second group of tristimulus values; and

Step 1-4: loading the first color calibrated profile in the mobile device to adjust the color of screen of the mobile device from the first group of tristimulus values to the second group of tristimulus values.

Step 2: creating a CIEXYZ color space of the mobile device by the second group of tristimulus values, and transforming the CIEXYZ color space to a sRGB color space via a 1D lookup table and a transformation matrix;

Step 3: obtaining a print color from a ICC profile of an output device by 3D lookup table and generating a second color calibrated profile by finding another color, similar to the print color from the ICC profile of the output device, in the sRGB color space through tone mapping; and

Step 4: simulating the print color on a screen of the mobile device by using the second color calibrated profile.

Therefore, the screen of the mobile devices can be adjusted to a better color and displayed with similar to the print color, the user can directly preview the printed photo on the screen thereby achieving saving print ink and time.

### BRIEF DESCRIPTION OF THE DRAWINGS

FIG. 1 is a schematic view of measuring points of three primary colors;

FIG. 2 is a flow view of the present invention.

### DETAILED DESCRIPTION OF THE PREFERRED EMBODIMENTS

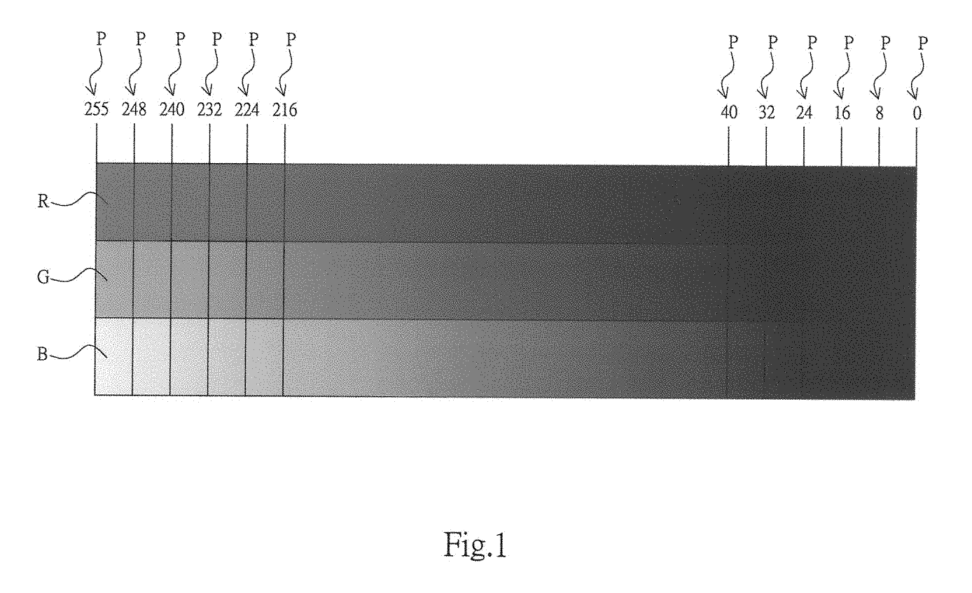

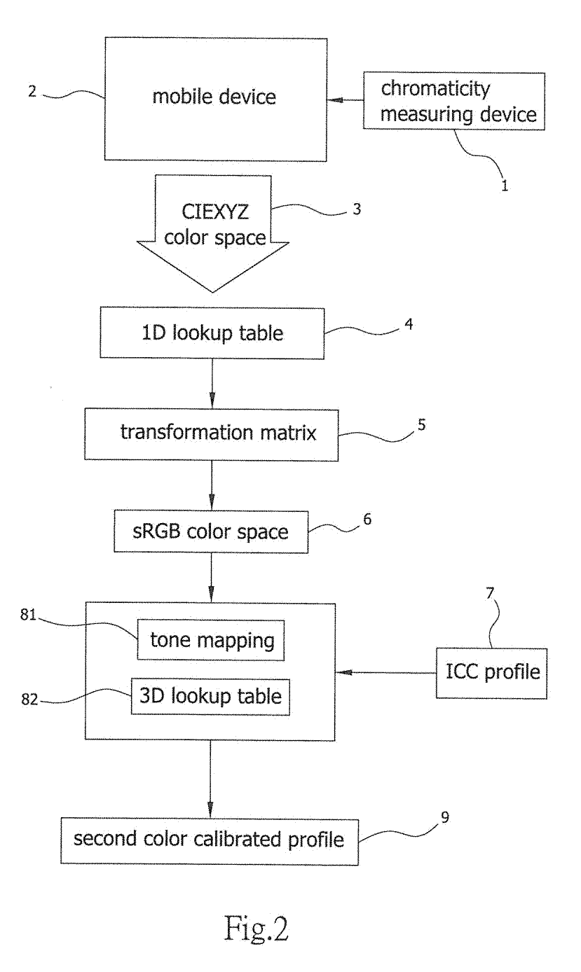

Referring to FIG. 1-2, the figures discloses a method of simulating print color on a mobile device (2) of the present invention, comprising: step 1: obtaining a second group of tristimulus values by a chromaticity measuring device (1) through a measuring method; wherein the measuring method comprises:

step 1-1: respectively selecting a plurality of measuring points (P) in red, green, and blue three primary color chromaticity coordinates from RGB (000, 000,000) to RGB (255, 255, 255), wherein the measuring points (P) are used for measuring three primary color chromaticity coordinates at an interval of every N value from the RGB (000, 000,000), and the N value is a positive integer value from 0 to 255, the preferred value is 8 or 16, if the value is too small, such as 2 or 4, the measuring time will be longer; if the value is too big, such as 32, 64 or above, the obtained values are too few to calibrate in later processes that is less effective;

step 1-2: collecting all of the measuring points through the chromaticity measuring device (1) to form a combination of colors, and obtaining the tristimulus values from the combination of colors to set up as a first group of tristimulus values; the FIG. 1 shows every interval of 8 for the measuring points (P), such as RGB (000,000,000), RGB (000,000,008), RGB (000,000,016) . . . RGB (248,248,248), RGB (255,255,255), and then all of the tristimulus values of the measuring points (P) are collected to form the first group of tristimulus values;

step 1-3: using an interpolation for filling missing values of the first group of tristimulus values caused by the N values therebetween to form a first color calibrated profile which is used to adjust the color of screen of the mobile device (2) from the first to the second group of tristimulus values, wherein the missing values are located between every measuring points (P), such as 1-7, 9-15, 17-23 . . . as shown in FIG. 1, so the missing values are needed to file up via interpolation; and step 1-4: loading the first color calibrated profile in the mobile device to adjust the color of screen of the mobile device from the first group of tristimulus values to the second group of tristimulus values, for example, the RGB (255,255,255) is a snow white color, however the color result measured from the chromaticity measuring device (1) is a white with light red, in such a situation, the first color calibrated profile can fix the first group of tristimulus values;

step 2 as shown in FIG. 2: creating a CIEXYZ color space (3) of the mobile device by the second group of tristimulus values, and transforming the CIEXYZ color space (3) to a sRGB color space (6) via a 1D lookup table (4) and a transformation matrix (5);

step 3: obtaining a print color from an International Color Consortium (ICC) profile (7) of an output device (such as printer, 3D printer) by 3D lookup table (82) and generating a second color calibrated profile (9) by finding another color, similar to the print color from the ICC profile of the output device, in the sRGB color space (6) through tone mapping (81); and

step 4: simulating the print color on a screen of the mobile device by using the second color calibrated profile (9), so the user can preview the print color on screen of the mobile device (2) thereby achieving saving print ink and time.

Therefore, the screen of the mobile devices can be adjusted to a better color and displayed with similar to the print color, the user can directly preview the printed photo on the screen thereby achieving saving print ink and time.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A method of simulating print color on mobile devices, comprising:
obtaining a second group of tristimulus values by a chromaticity measuring device through a measuring method;
creating a CIEXYZ color space of the mobile device by the second group of tristimulus values, and transforming the CIEXYZ color space to a sRGB color space via a 1D lookup table and a transformation matrix;
obtaining a print color from a ICC profile of an output device by 3D lookup table and generating a second color calibrated profile by finding another color, similar to the print color from the ICC profile of the output device, in the sRGB color space through tone mapping; and
simulating the print color on a screen of the mobile device by using the second color calibrated profile.

2. The method of simulating print color on the mobiles device according to claim 1, wherein the measuring method comprises:
respectively selecting a plurality of measuring points in red, green, and blue three primary color chromaticity coordinates from RGB (000, 000,000) to RGB (255, 255, 255), wherein the measuring points are used for measuring three primary color chromaticity coordinates at an interval of every N value from the RGB (000, 000,000), and the N value is a positive integer value from 0 to 255;
collecting all of the measuring points through the chromaticity measuring device to form a combination of colors, and obtaining the tristimulus values from the combination of colors to set up as a first group of tristimulus values;
using an interpolation for filling missing values of the first group of tristimulus values caused by the N values therebetween to form a first color calibrated profile which is used to adjust the color of screen of the mobile device from the first to the second group of tristimulus values; and
loading the first color calibrated profile in the mobile device to adjust the color of screen of the mobile device from the first group of tristimulus values to the second group of tristimulus values.

3. The method of simulating print color on the mobile devices according to claim 1 or 2, wherein the output device defines a printer.

4. The method of simulating print color on the mobile devices according to claim 1 or 2, wherein the output device defines a 3D printer.

5. The method of simulating print color on the mobile devices according to claim 1 or 2, wherein the chromaticity measuring device defines a 2D color analyzer.

6. The method of simulating print color on the mobile devices according to claim 1 or 2, wherein the chromaticity measuring device defines a high resolution camera with color calibration.

7. The method of simulating print color on the mobile devices according to claim 2, wherein the N value is 8.

8. The method of simulating print color on the mobile devices according to claim 2, wherein the N value is 16.
